(19) United States
(12) Patent Application Publication
(10) Pub. No.: US 2016/0067948 A1
(43) Pub. Date: Mar. 10, 2016

(54) ENCAPSULATION STRUCTURE AND METHOD FOR MAKING SAME

(71) Applicant: HON HAI PRECISION INDUSTRY CO., LTD., New Taipei (TW)

(72) Inventors: HSIN-HUA CHANG, New Taipei (TW); JEN-TSORNG CHANG, Tu-Cheng (TW); SEI-PING LOUH, New Taipei (TW)

(21) Appl. No.: 14/559,577

(22) Filed: Dec. 3, 2014

(30) Foreign Application Priority Data
Sep. 4, 2014 (TW) 103130522

(51) Int. Cl. B32B 17/00; C03C 15/00; C03C 23/00; C03B 23/02; C03C 17/00

(52) U.S. Cl. CPC B32B 17/00; C03B 23/02; C03C 17/007; C03C 23/0025; C03C 15/00; B82Y 20/00

(57) ABSTRACT

An encapsulation structure includes a first substrate, a second substrate, and a quantum dot layer. Both the first substrate and the second substrate are made of glass. The edge of the first substrate and the edge of the second substrate are sealed together to encapsulate the quantum dot layer between the first substrate and the second substrate.

### FIELD

The present disclosure generally relates to a encapsulation structure containing quantum dot and a method for making the encapsulation structure.

### BACKGROUND

A quantum dot is a nanocrystal made of semiconductor materials that are small enough to exhibit quantum mechanical properties. Nowadays, quantum dot is widely used in many applications, such as transistors, solar cells, LEDs, and laser diodes. There is a need to encapsulate the quantum dot to prevent water and/or oxygen from affecting the properties of the quantum dot during use.

### BRIEF DESCRIPTION OF THE DRAWINGS

Implementations of the present technology will now be described, by way of example only, with reference to the attached figures.

FIG. 1 is a cross-sectional view of an exemplary embodiment of an encapsulation structure having a first substrate.

FIG. 2 is a cross-sectional view of the first substrate with a photoresist layer.

FIG. 3 is a cross-sectional view after the photoresist layer of FIG. 2 has been exposed and developed.

FIG. 4 is a cross-sectional view after the first substrate of FIG. 3 has been etched.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series, and the like.

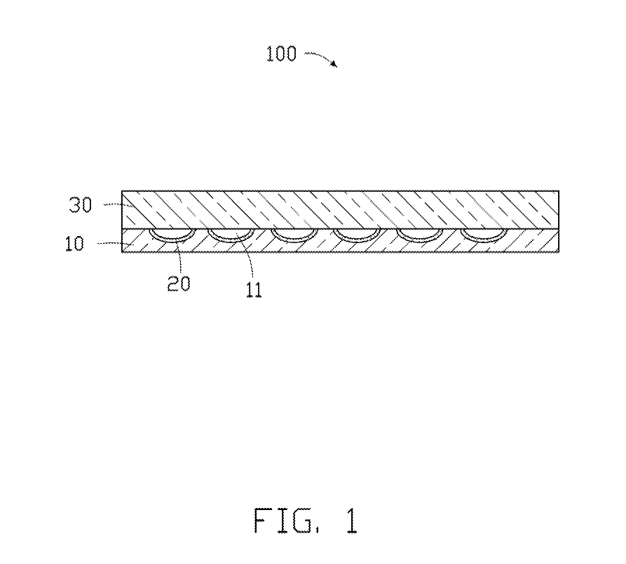

FIG. 1 illustrates an encapsulation structure 100 according to an exemplary embodiment. The encapsulation structure 100 includes a first substrate 10, a second substrate 30 covering the first substrate 10, and a quantum dot layer 20 formed between the first substrate 10 and the second substrate 30. Both the first substrate 10 and the second substrate 30 are made of glass. The edge of the first substrate 10 and the edge of the second substrate 30 are sealed together to form a sealed space to receive the quantum dot layer 20, thus encapsulating the quantum dot layer 20 between the first substrate 10 and the second substrate 30. The encapsulation structure 100 can be used in many applications, such as light emitting device, display device, and biomedicine.

In this embodiment, the first substrate 10 defines a plurality of grooves 11, and the quantum dot layer 20 is formed in the plurality of grooves 11. The grooves 11 have a depth in a range of about 5 μm to about 10 μm. The grooves 11 can be formed by chemical etching or laser engraving the first substrate 10.

In this embodiment, both the first substrate 10 and the second substrate 30 are flexible and ultrathin glass having a thickness of no more than 0.2 mm. The thickness of the first substrate 10 and the thickness of the second substrate 30 can be the same or different.

The quantum dot layer 20 can be formed by coating a colloidal quantum dot on the first substrate 10. The colloidal quantum dot contains a red quantum dot, a green quantum dot, and polymer glue. The weight ratio of the red quantum dot to the green quantum dot can be adjusted according to the requirements of application. In this embodiment, the weight ratio of the red quantum dot to the green quantum dot is in a range from about 1:2 to about 2:1. The polymer glue is selected from a group consisting of acrylic resin glue, organic siloxane glue, acrylate modified polyurethane glue, acrylate modified silicone resin glue, epoxy resin glue, and any combination thereof.

The red quantum dot and the green quantum dot can be common quantum dot material known in the field, such as II-VI group quantum dot, III-V group quantum dot, IV-VI group quantum dot, I-III-VI group quantum dot, and II-III-VI group quantum dot.

The encapsulation structure 100 can effectively prevent water and/or air from permeating into the encapsulation structure 100, which can make the quantum dot layer 20 maintain a good emission effect. The edge of the first substrate 10 and the edge of the second substrate 30 can be sealed together by laser welding or glass solder sealing.

A method for making the encapsulation structure 100 may include the following steps:

A first substrate 10 is provided. The first substrate 10 is a flexible and ultrathin glass having a thickness of no more than 0.2 mm.

A quantum dot layer 20 is formed on the first substrate 10. Forming the quantum dot layer 20 on the first substrate 10 further includes the following steps:

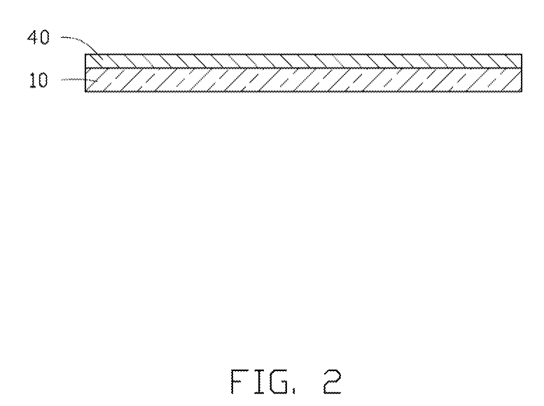

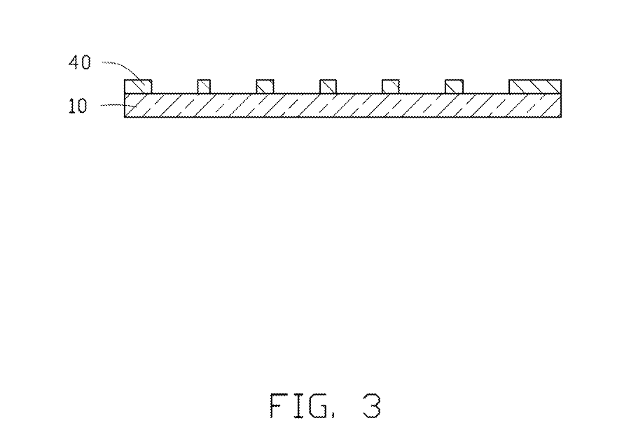

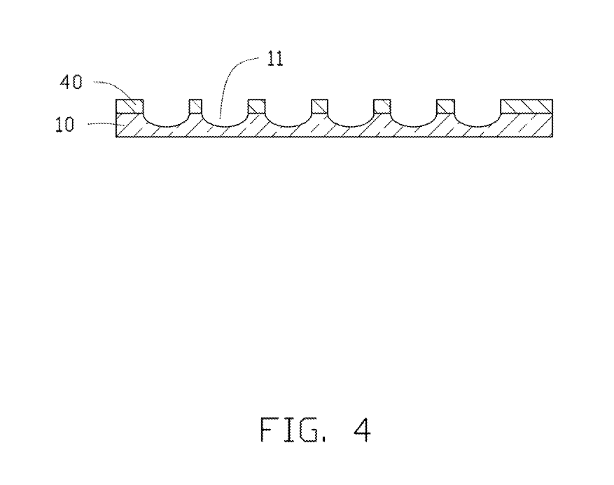

A photoresist layer 40 is formed on one surface of the first substrate 10 as shown in FIG. 2. The photoresist layer 40 is exposed and developed to allow a partial surface of the first substrate 10 to be uncovered, as shown in FIG. 3. As shown in FIG. 4, the first substrate 10 is then etched to form a plurality of grooves 11. The etching method can be carried out by coating a hydrofluoric acid solution on the partial surface of the first substrate 10 that has been left uncovered by the photoresist layer 40, or laser engraving the partial surface of the first substrate 10 that has been left uncovered by the photoresist layer 40. The hydrofluoric acid solution can have a concentration of about 5% to about 10%. The grooves 11 can have a depth in a range of about 5 μm to about 10 μm. The first substrate 10 is cleaned to remove the remaining hydrofluoric acid solution on the first substrate 10.

A red quantum dot powder and a green quantum dot powder are dispersed in a polymer glue to obtain a colloidal quantum dot. Both the red quantum dot and the green quantum dot can have a weight percentage of less than 5% in the colloidal quantum dot. In this embodiment, the weight ratio of the red to green quantum dot is in a range from about 1:2 to about 2:1. The polymer glue is selected from a group consisting of acrylic resin glue, organic siloxane glue, acrylate modified polyurethane glue, acrylate modified silicone resin glue, epoxy resin glue, or any combination thereof. The colloidal quantum dot is coated in the grooves 11 of the first substrate 10 to form the quantum dot layer 20. Finally, the photoresist layer 40 remaining on the first substrate 10 is removed.

A second substrate 30 is provided. The second substrate 30 is a flexible and ultrathin glass having a thickness of no more than 0.2 mm.

The edge of the first substrate 10 and the edge of the second substrate 30 are sealed together to form a sealed space to receive the quantum dot layer 20, thereby the quantum dot layer 20 is encapsulated between the first substrate 10 and the second substrate 30.

### EXAMPLE 1

In this example, both the first substrate 10 and the second substrate 30 were ultrathin glass having a thickness of less than 0.1 mm. One surface of the first substrate 10 was coated by a photoresist to form a photoresist layer 40. The photoresist layer 40 was exposed and developed to allow the surface of the first substrate 10 to be partially uncovered by the photoresist layer 40. The surface of the first substrate 10 not covered by the photoresist layer 40 was etched to form a plurality of grooves 11 having an average depth of about 5 μm by a hydrofluoric acid solution having a concentration of about 5%.

A red quantum dot powder and a green quantum dot powder were dispersed in an acrylic resin glue to obtain a colloidal quantum dot. The colloidal quantum dot was coated in the grooves 11 of the first substrate 10 to form a quantum dot layer 20. The remaining photoresist layer 40 was removed from the first substrate 10. The edge of the first substrate 10 and the edge of the second substrate 30 were sealed together by laser welding; thereby the quantum dot layer 20 was encapsulated between the first substrate 10 and the second substrate 30.

### EXAMPLE 2

In this example, both the first substrate 10 and the second substrate 30 were ultrathin glass having a thickness of no more than 0.2 mm. One surface of the first substrate 10 was coated by a photoresist to form a photoresist layer 40. The photoresist layer 40 was exposed and developed to allow the surface of the first substrate 10 to be partially uncovered by the photoresist layer 40. The surface of the first substrate 10 not covered by the photoresist layer 40 was etched to form a plurality of grooves 11 having an average depth of about 10 μm by a hydrofluoric acid solution having a concentration of about 5%.

A red quantum dot powder and a green quantum dot powder were dispersed in an acrylic resin glue to obtain a colloidal quantum dot. The colloidal quantum dot was coated in the grooves 11 of the first substrate 10 to form a quantum dot layer 20. The photoresist layer 40 remaining was removed from the first substrate 10. The edge of the first substrate 10 and the edge of the second substrate 30 were sealed together by laser welding; thereby the quantum dot layer 20 was encapsulated between the first substrate 10 and the second substrate 30.

### EXAMPLE 3

In this example, both the first substrate 10 and the second substrate 30 were ultrathin glass having a thickness of less than 0.15 mm. One surface of the first substrate 10 was coated by a photoresist to form a photoresist layer 40. The photoresist layer 40 was exposed and developed to allow the surface of the first substrate 10 to be partially uncovered by the photoresist layer 40. The surface of the first substrate 10 not covered by the photoresist layer 40 was etched to form a plurality of grooves 11 having an average depth of about 10 μm by a hydrofluoric acid solution having a concentration of about 5%.

A red quantum dot powder and a green quantum dot powder were dispersed in an acrylic resin glue to obtain a colloidal quantum dot. The colloidal quantum dot was coated in the grooves 11 of the first substrate 10 to form a quantum dot layer 20. The photoresist layer 40 remaining was removed from the first substrate 10. The edge of the first substrate 10 and the edge of the second substrate 30 were sealed together by laser welding; thereby the quantum dot layer 20 was encapsulated between the first substrate 10 and the second substrate 30.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiments of the disclosure.

1. An encapsulation structure comprising:
a first substrate, the first substrate being made of glass;
a second substrate, the second substrate being made of glass; and
a quantum dot layer formed between the first substrate and the second substrate;
wherein the edge of the first substrate and the edge of the second substrate are sealed together to encapsulate the quantum dot layer between the first substrate and the second substrate, the first substrate defines a plurality of grooves having a depth in a range of 5 μm to 10 μm, and the quantum dot layer is formed in the plurality of grooves.

2.-3. (canceled)

4. The encapsulation structure as claimed in claim 1, wherein the first substrate has a thickness no greater than 0.2 mm, and the second substrate has a thickness no greater than 0.2 mm.

5. The encapsulation structure as claimed in claim 1, wherein the quantum dot layer is formed by using a colloidal quantum dot, the colloidal quantum dot comprises a red quantum dot, a green quantum dot, and polymer glue.

6. The encapsulation structure as claimed in claim 5, wherein the weight ratio of the red quantum dot to the green quantum dot is in a range from 1:2 to 2:1.

7. The encapsulation structure as claimed in claim 5, wherein the polymer glue is selected from a group consisting of acrylic resin glue, organic siloxane glue, acrylate modified polyurethane glue, acrylate modified silicone resin glue, epoxy resin glue, and any combination thereof.

8. A method for making an encapsulation structure comprising:
providing a first substrate, the first substrate being made of glass;
defining a plurality of grooves in the first substrate, the grooves having a depth in a range of 5 μm to 10 μm;
forming a quantum dot layer in the plurality of grooves;
providing a second substrate, the second substrate being made of glass; and sealing the edge of the first substrate and the edge of the second substrate together to encapsulate the quantum dot layer between the first substrate and the second substrate.

9. The method as claimed in claim 8, wherein forming the quantum dot layer on the first substrate comprises steps of mixing a red quantum dot powder, a green quantum dot powder, and polymer glue together to obtain a colloidal quantum dot; and coating the colloidal quantum dot in the plurality of grooves to form the quantum dot layer.

10. The method as claimed in claim 9, wherein the polymer glue is selected from a group consisting of acrylic resin glue, organic siloxane glue, acrylate modified polyurethane glue, acrylate modified silicone resin glue, epoxy resin glue, and any combination thereof.

11. The method as claimed in claim 9, wherein the red quantum dot has a weight percentage of less than 5% in the colloidal quantum dot, and the green quantum dot has a weight percentage of less than 5% in the colloidal quantum dot, the weight ratio of the red quantum dot to the green quantum dot is in a range from 1:2 to 2:1.

12. The method as claimed in claim 8, wherein defining a plurality of grooves in the first substrate comprises steps of forming a photoresist layer on one surface of the first substrate; exposing and developing the photoresist layer to allow the surface of the first substrate to be partially uncovered by the photoresist layer; and etching the surface of the first substrate that has been left uncovered by the photoresist layer to form a plurality of grooves by using a hydrofluoric acid solution or laser.

13. (canceled)

14. The method as claimed in claim 12, wherein the method further comprises a step of removing the photoresist layer remaining on the first substrate after the step of forming the quantum dot layer on the first substrate.

15. The method as claimed in claim 8, wherein the first substrate has a thickness of no more than 0.2 mm, and the second substrate has a thickness of no more than 0.2 mm.

16. The method as claimed in claim 8, wherein the edge of the first substrate and the edges of the second substrate are sealed together by laser welding or glass solder sealing.
